(19) United States
(12) Patent Application Publication
(10) Pub. No.: US 2006/0126470 A1
(43) Pub. Date: Jun. 15, 2006

(54) Digital data recording method, recording apparatus and reproducing apparatus

(76) Inventor: Taku Hoshizawa, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/298,585

(22) Filed: Dec. 12, 2005

(30) Foreign Application Priority Data
Dec. 13, 2004 (JP) 2004-359311

(51) Int. Cl. G11B 5/09

(52) U.S. Cl. 369/53.2; 369/47.1

(57) ABSTRACT

In a recording method of a write-once optical disk which has a lead-in area, a user area and a lead-out area and to which a logical over-write processing is performed using disk structure definition information and a defect list table recorded to the lead-in area, the disk structure definition information includes information regarding at least one of the disk structure definition information and the defect list table that is to be referred to for a logical over-write cancellation processing, to thereby cancel recovery of a file system at the time of the occurrence of an accident in a data recording system to which a logical over-write processing is applied, or an over-write processing.

### INCORPORATION BY REFERENCE

The present application claims priority from Japanese application JP 2004-359311 filed on Dec. 13, 2004, the content of which is hereby incorporated by reference into this application.

### BACKGROUND OF THE INVENTION

1. Field of the Invention

This invention relates to a recording/reproducing technology for recording digital data to a recording medium, particularly to a write-once optical disk.

2. Description of the Related Art

An example of apparatuses for recording and reproducing digital data to a recording medium is a DVD-RAM recording/reproducing apparatus (drive) described in the reference 1, i.e. “Standard ECMA-272: 120 mm DVD Rewritable Disk (DVD-RAM)”, ECMA, 1999 (pp. 43-55).

When a disk is loaded or a power source is turned on, this DVD-RAM drive first inspects a recorded content of drive management information such as a defect management area (DMA) arranged in lead-in and lead-out and checks whether or not DVD-RAM has already been formatted physically. When DVD-RAM is not physically formatted, the drive waits for a physical format command from a host.

When DVD-RAM is physically formatted, the DVD-RAM drive executes a recording preparation processing such as a calibration processing and a logical matching verification processing and then waits for a command from the host. Receiving any “command” from the host, the DVD-RAM examines the meaning of the command. The DVD-RAM drive executes the recording processing of user data when the command is a recording command and a reproduction processing from the recorded data on DVD-RAM to the user data when the command is a reproduction command. The DVD-RAM drive executes a corresponding processing when the command is a disk ejection command, for example. Generally, these kinds of processing are normally finished but in a very rare case, the processing cannot be finished normally for an unexpected reason. For example, when the optical disk contains a defect inside a user area and recording of the user data to the recording command proves unsuccessful, an error restore processing such as a retry processing or a linear replacement processing is conducted.

During the recording processing of the user data in ordinary DVD-RAM drives, recording quality is confirmed by reproducing in practice the recorded data from DVD-RAM to judge whether or not recording is normally made. As a result, reliability of the optical disk is improved by executing a linear replacement processing for arranging the user data to a spare area in place of a user area, whenever necessary. The spare area arranged adjacent to lead-out extends from the lead-out side to the lead-in side and is continuously used. This is to expand the size of the spare area in accordance with the number of defects that increases with degradation of characteristics of the recording layer of the optical disk that occurs through repetition of over-write.

The reference 1 stipulates that corresponding information of the user area and the spare area representing the result of this linear replacement processing be recorded as a defective list (DL) to DMA.

In the write-once optical disks such as DVD-R, data recording is continuously made in an ascending direction inside the logical address space managed generally by the host with several points of the user area as starting points. To cope with this recording system, logical division of the user area called “R zone” is made in DVD-R and two kinds of address information, that is, the leading address of the R zone as the starting point of the recording data and the last recorded address (LRA) of the continuous recording area from the leading address inside the R zone, are recorded to the recording area management data (RMD) inside the recording area management information area (RMA).

The method of managing the recorded area inside the data area by using this R zone is standardized by the reference 2, that is, “Standard ECMA-279: 80 mm (1, 23 Gbytes per side) and 120 mm (3, 95 Gbytes per side) DVD-Recordable Disk (DVD-R)”, ECMA, 1998 (pp. 60-61).

JP-A-2004-171714 (paragraph [0047]) and JP-A-2004-303381 (paragraph [0036]) describe the method that accomplish logical over-write in a write-once optical disk having a recording layer that cannot be over-written physically such as DVD-R by expanding a linear replacement processing used for defect management of DVD-RAM.

One of the file systems for managing files on an optical disk is UDF (Universal Disk Format). When the host loads an optical disk into the drive and reads out file data from the optical disk, file retrieval is made in the procedures of “AVDP (Anchor Volume Descriptor)→VDS (LVD (Logical Volume Descriptor))→MD (Meta Data)→FE (File Entry) of file→FSD (File Set Descriptor)→ICB (Information Control Block) of route directory→FID (File Identifier Descriptor) inside route directory→ . . . →ICB of file data”. Data reproduction is made by using this retrieval result.

AVDP is the point that the host first reads out and all the files on the optical disk can be reached from this point. AVDP is recorded to at least two positions of a sector of the logical block number (LBN) 256, the last sector (Z) and a sector of Z-256. The detail of this UDF is described in the reference 3, i.e. “Universal Disk Format Specification Revision 2.50”, OSTA, 2003.

### SUMMARY OF THE INVENTION

The logical over-write technology in the write-once optical disk described in JP-A-2004-171714 and JP-A-2004-303381 is useful for rewriting file system management information, particularly anchor data recorded to a fixed address to be referred to at the start of data reproduction from the optical disk such as re-writing of ABDP in UDF.

However, the references cited above do not put any description on a restore method of a file system at the time of occurrence of an accident in a data recording system employing a logical over-write processing and measures for canceling the over-write processing.

To achieve the objects of the invention for solving the problems in the prior art, this invention includes the following solutions (1) to (4).

(1) A recording method of a write-once optical disk for performing a logical over-write processing by using disk structure definition information having lead-in, user area and lead-out whereby recording is made to lead-in, and a defect list able, wherein at least one of the disk structure definition information and the defect list table contains information about the disk structure definition information or the defect list table that is looked up for a logical over-write erase processing.

(2) An optical disk recording apparatus for performing a logical over-write processing for a write-once optical disk by using disk structure definition information and a defect list table, wherein recording to an optical disk is made after information about the disk structure definition information or the defect list table that is looked up for a logical over-write erase processing is added to at least one of the disk structure definition information and the defect list table.

(3) An optical disk reproducing apparatus for reproducing a write-once optical disk to which disk structure definition information used for logical over-write and a defect list able are recorded updates the defect list table by referring to the disk structure definition information or information about the defect list table contained in at least one of the disk structure definition information and the defect list table.

(4) An optical disk reproducing apparatus for reproducing a write-once optical disk to which disk structure definition information having lead-in, user area and lead-out and used for logical over-write and a defect list table are continuously updated and recorded inside a recording area management information area of lead-in searches a defect list table designated by a defect list table restore command from inside the recording area management information area and updates the defect list table.

The invention can accomplish a cancel processing of a recovery processing and of an over-write processing of a file system at the time of the occurrence of an accident in a data recording system of a write-once optical disk using logical over-write, too.

Other objects, features and advantages of the invention will become apparent from the following description of the embodiments of the invention taken in conjunction with the accompanying drawings.

### BRIEF DESCRIPTION OF THE DRAWINGS

FIG. 1 is a flowchart showing operations for DLT (Defect List Table) recording and restore commands of a write-once optical disk drive;

FIG. 2 is an explanatory view showing a structure of a data frame;

FIG. 3 is an explanatory view showing a structure of an ECC block;

FIG. 4 is an explanatory view showing a construction of an optical disk drive;

FIG. 5 is an explanatory view showing a correspondence of a logical address space and a physical address of an optical disk;

FIG. 6 is an explanatory view showing a recording type optical disk having a defect management function;

FIG. 7 is an explanatory view showing a linear replacement processing and DL of the recording optical disk;

FIG. 8 is an explanatory view showing a recording area management method of a write-once optical disk;

FIG. 9 is an explanatory view showing a construction of a write-once optical disk that has a logical over-write function;

FIG. 10 is an explanatory view showing an arrangement of drive management information of the write-once optical disk that has the logical over-write function;

FIG. 11 is an explanatory view showing a structure of DDS (Disk Definition Structure) having a restored DLT address;

FIG. 12 is an explanatory view showing a structure of DDS having a restored DDS address;

FIG. 13 is an explanatory view showing a structure of DDS having a restored DDS flag;

FIG. 14 is an explanatory view showing a structure of DDS having a restored DLT address;

FIG. 15 is a flowchart showing operations for a recording command and a DLT restore command of the write-once optical disk drive:

FIG. 16 is a flowchart showing operations for a disk ejection command and a DLT restore command of the write-once optical disk drive;

FIG. 17 is a flowchart showing operations for a DLT recording command and a restore command of the write-once optical disk drive;

FIG. 18 is a flowchart showing operations for a disk ejection command and a DLT restore command of the write-once optical disk drive;

FIG. 19 is a flowchart showing operations for a DLT recording command and a restore command of the write-once optical disk drive;

FIG. 20 is a flowchart showing operations for a DLT restore command of the write-once optical disk drive;

FIG. 21 is a flowchart showing operations for a DLT restore command of the write-once optical disk drive;

FIG. 22 is a flowchart showing operations for a DLT restore command of the write-once optical disk drive; and

FIG. 23 is an explanatory view showing a structure of a user area to which file system management information and file are recorded.

### DESCRIPTION OF THE EMBODIMENTS

Embodiments of the invention will be hereinafter explained with reference to the accompanying drawings.

One of the forms for executing the invention is an optical disk drive.

An example of a write-once optical disk drive includes an optical disk, an optical head to which a laser diode and a light detector are mounted, a recording/reproduction signal processing circuit for executing an encoding processing for recording and a decoding processing for reproduction, a control microcomputer for executing operation management of each component and each circuit, a servo circuit, an interface circuit with a host, containing RAM, and an input/output terminal connected to the host.

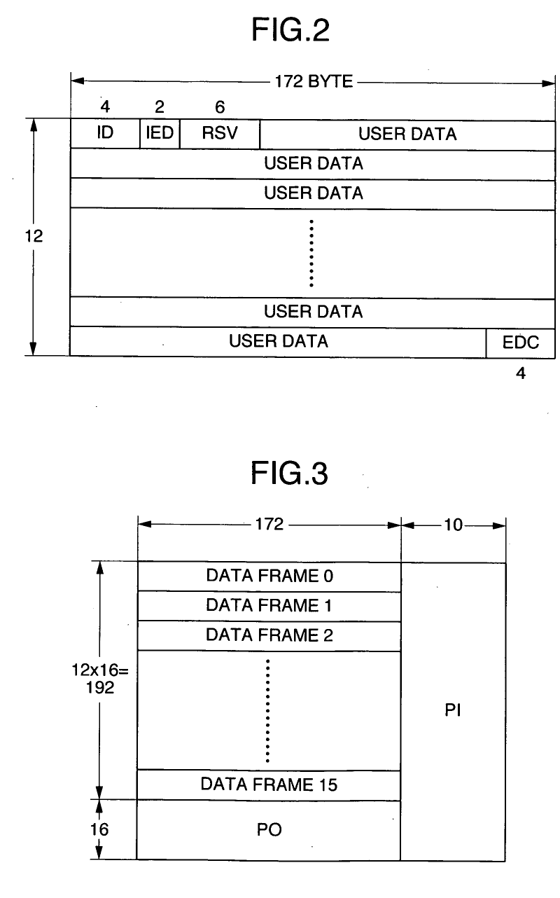

To begin with, a format of recording data used for the explanation of the invention and a basic construction of a drive will be explained with reference to FIGS. 2 to 4.

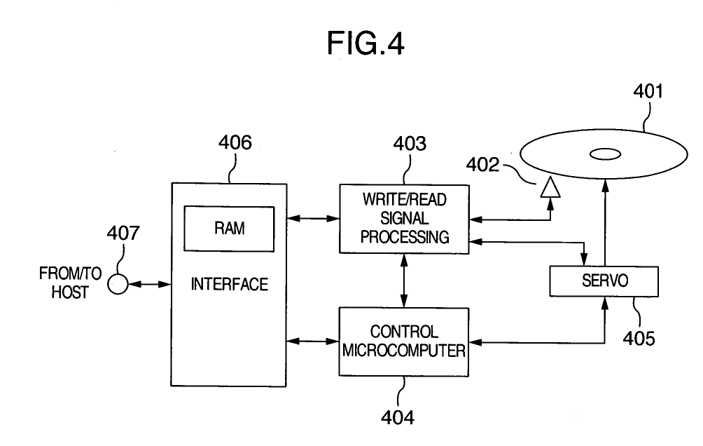

FIG. 4 shows an example of the construction of an optical disk drive. In the drawing, reference numeral 401 denotes an optical disk. Reference numeral 402 denotes an optical head having a laser diode and a light detector mounted thereto. Reference numeral 403 denotes a recording/reproduction signal processing circuit for executing an encoding processing for recording and a decoding processing for reproduction. Reference numeral 404 denotes a microcomputer for executing operation management of each component and each circuit. Reference numeral 405 denotes a servo circuit. Reference numeral 406 denotes an interface circuit with a host that includes RAM. Reference numeral 407 denotes an input/output terminal connected to the host through a cable.

During reproduction, data recorded to the optical disk 401 is read out by the optical head 402 and the recording/reproduction processing circuit 403 executes the decoding processing. The decoding processing includes a demodulation processing, an error correction processing and a de-scramble processing. The user data acquired after this decoding processing is stored in RAM inside the interface circuit 406 and is then outputted to an external personal computer or the host (not shown) such as an MPEG board through the input/output terminal 407. The control microcomputer 404 receives a command from the host, etc, executes rotation control of the optical disk 401 by using the servo circuit 405 and focus and tracking control of the optical head 403, gains access to a target position of the designated optical disk 401 and executes reproduction control of the drive as a whole. During recording, user data is inputted from the external host through the input/output terminal 407. The user data so inputted is stored in RAM inside the interface circuit 406 and the recording/reproduction signal processing circuit 403 executes a scramble processing, an error correction encoding processing, a modulation processing, and so forth. The user data is thereafter written into the optical disk 401 through the optical head 402. The control microcomputer 404 receives a command from the host, gains access to a designated recording position of the optical disk 401 by using the servo circuit 405 and executes recording control of the drive as a whole.

The detail of the encoding process from the user data to the recording data during recording handled hereby will be explained with reference to FIGS. 2 and 3.

FIG. 2 shows an example of a constitution method of a data frame. The term “data frame” represents a data string as a set of user data and information data for managing this user data. The user data of 2,048 bytes inputted from the input/output terminal 407 includes a 4-byte data identification code (ID) for data identification, 2-byte IED (ID Error Detection code) and 6-byte RSV (Reserved Area) as a reserved data area. A 4-byte error detection code EDC (Error Detection Code) for detecting error contained in the data is added to the last part of this data string, forming eventually the 2,064-byte data frame. Each data frame is handled as data block of 172 bytes by 12 columns.

FIG. 3 shows a constitution method of the ECC block. Generally, this ECC block is a data unit as a recording/reproduction unit of the drive. The data frames of 172 bytes by 12 columns constituted as shown in FIG. 2 are subjected to the scramble processing and then constitute the ECC block in the sixteen data frame units. A 16-byte PO (Parity of Outer code) is added to each column in the longitudinal direction, forming 208 rows in total. A 10-byte PI (Parity of Inner code) is added to the data of each expanded row to form 182-byte data. In this way, the ECC block is constituted by the user data of 182-byte by 208 rows and 2,048-byte by 16.

After this ECC block is generated inside the recording/reproduction signal processing circuit 403, frequency modulation for limiting frequency components contained in the data is executed as a final processing of encoding, not shown.

In a recording/reproducing apparatus that executes a linear replacement processing such as a DVD-RAM drive, confirmation is made by reproducing data on the disk during the recording processing of the user data immediately after the data is recorded, comparing the reproduced data with the user data remaining in RAM or executing an error correction processing to detect an error number contained in the reproduced data and confirming whether or not the data is normally recorded to the optical disk. When recording is not judged as being normally made as a result of this confirmation, recording to the same position (address) is made repeatedly and when recording cannot be normally recorded to this position even after this operation, that is, when this position is judged as defective, the linear replacement processing is carried out to record the user data left in RAM inside the interface circuit 406 to the spare area.

Generally, the linear replacement processing is made in the ECC block as the recording/reproduction unit as shown in FIG. 3. In the data format explained with reference to FIGS. 2 and 3, the data identification code (ID) is added in the data frame unit. Therefore, the leading part of the ECC block is some multiples of 16 and the correspondence to the logical address is the data frame unit. To have the invention more easily understood, however, the explanation will be given by neglecting the lower order four (4) bits of the data identification code (ID), allocating one physical address to the ECC block and associating one logical address with this physical address. Therefore, the data unit of the recording/reproduction command from the host has also the ECC block unit.

An example of logical over-write methods in the write-once optical disk will be explained next.

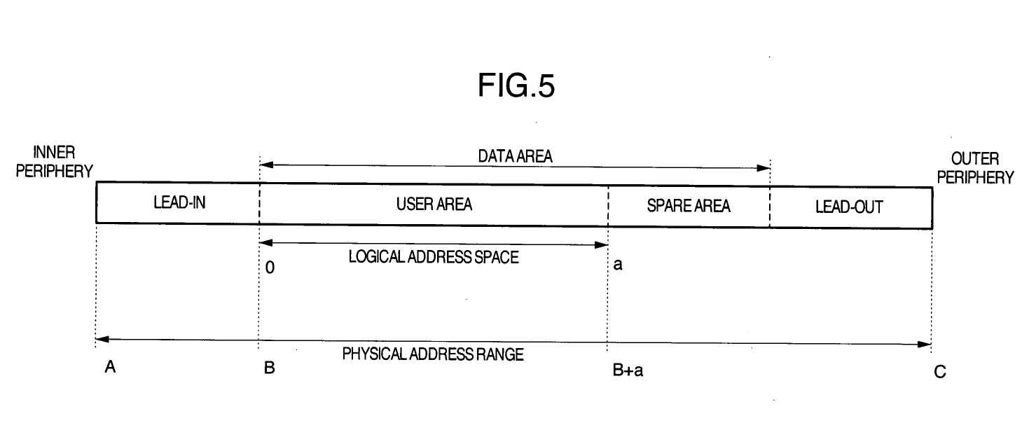

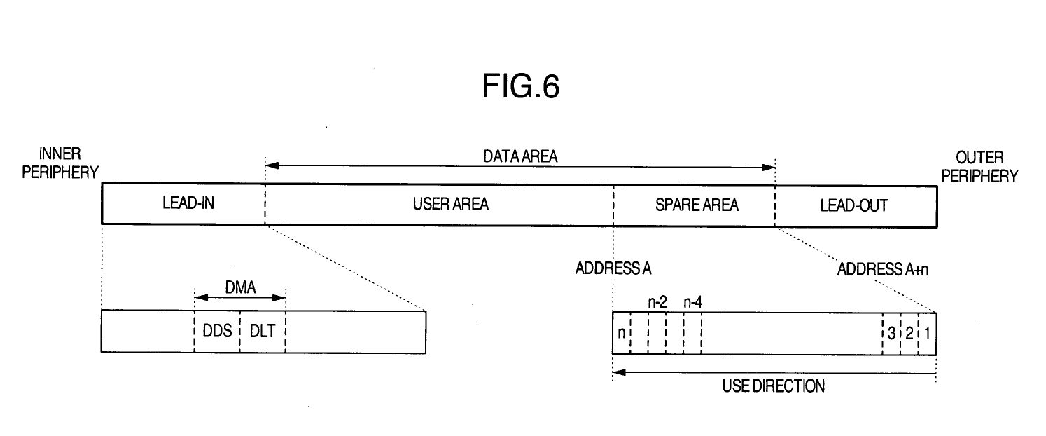

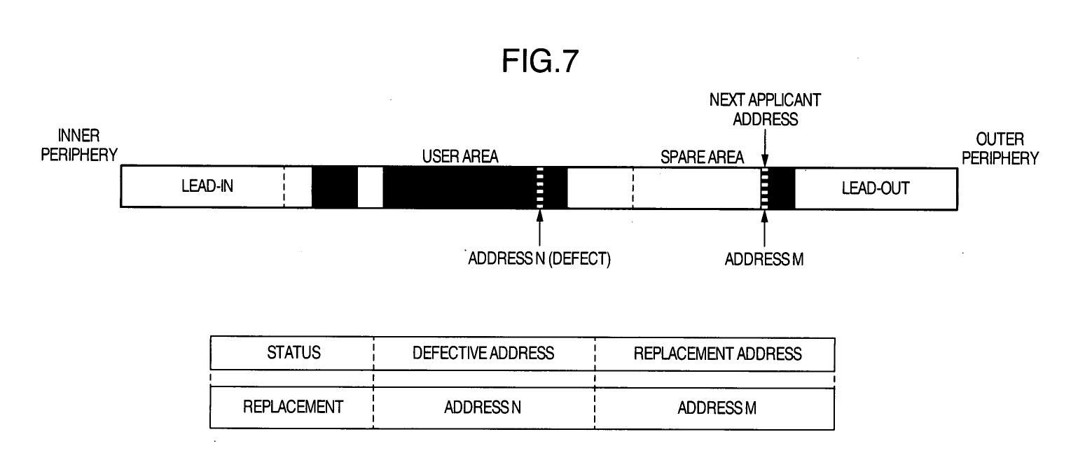

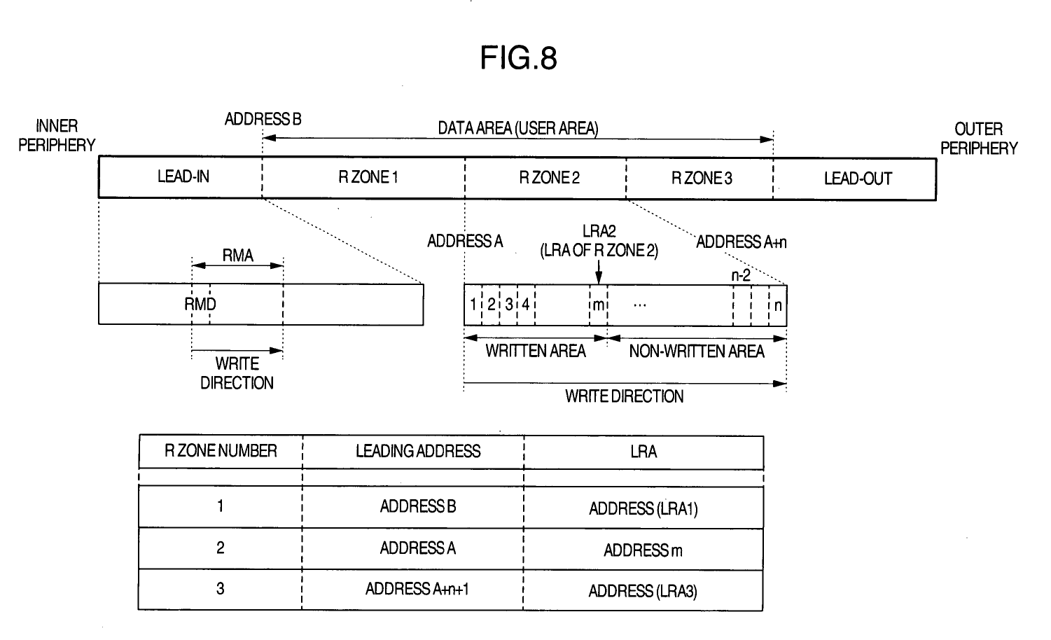

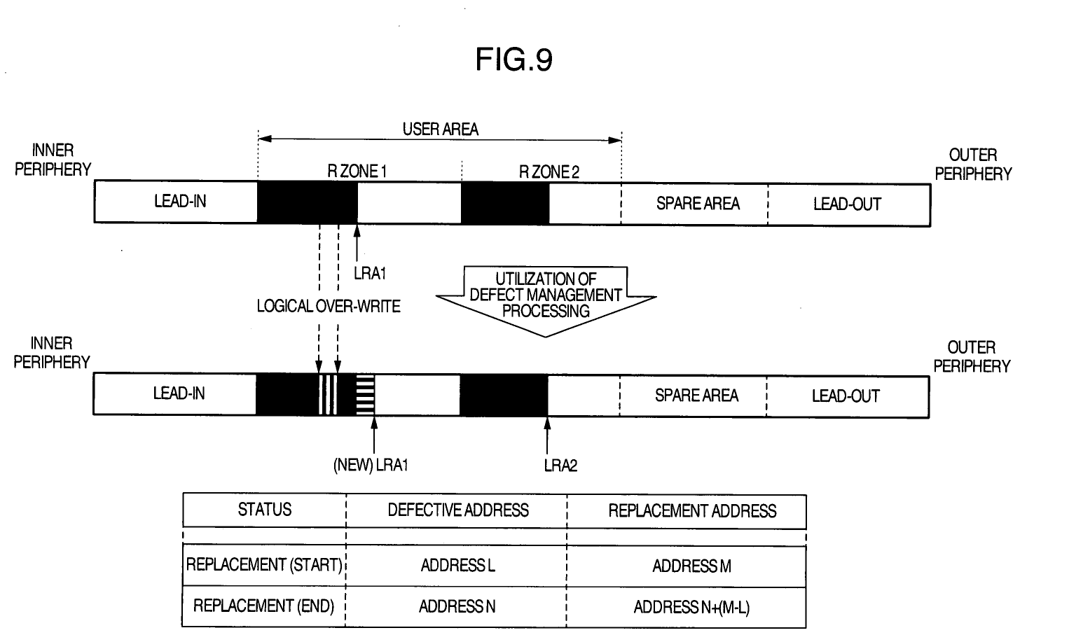

The explanation will be given step-wise. First, FIG. 5 shows the relation between the logical address space used by the host and the physical address on the optical disk. Next, FIGS. 6 and 7 explain the summary of areas necessary for defect management executed in DVD-RAM, etc, and the defect management method. FIG. 8 explains a recording system and a recording area management method executed in DVD-R, or the like. Thereafter, the logical over-write method in the write-once optical disk will be explained with reference to FIG. 9.

FIG. 5 shows the relation between the physical address of the optical disk the area of which is divided in accordance with objects, and the logical address contained in the recording/reproduction command from the host. It will be assumed herby that the optical disk is logically divided into lead-in, data area and lead-out. It will be further assumed hereby that the data area is logically divided into a user area and a spare area for the purpose of defect management. The start physical addresses of lead-in and data area are A and B, respectively, and an end physical address of lead-out is C. Though the relation A>B>C is established in some cases depending on the physical address standard of the optical disk, the explanation will be given on the assumption that the relation A<B<C is established. In this case, the logical address is allocated to only the user area under the initial condition and a physical address B+n is allocated to a logical address n when no replacement exists. When B+n has already been allocated as the replacement object to other address, a physical address of the replacement destination corresponds to the logical address n. Therefore, when the last address of the user area is B+a, a maximum space from 0 to a can be used as the logical address space.

FIG. 6 shows a disk for conceptually explaining defect management by a linear replacement method that is generally employed in the recording type optical disk. The drawing shows that the optical disk is logically divided into areas in accordance with an object. For the sake of convenience, the optical disk is divided into lead-in, a data area and lead-out and the data area is logically divided into a user area and a spare area in accordance with the object. Division information of the data area, disk definition structure (DDS) relating to a logical structure of an applicant address to be next used in the spare area and a defect list table (DLT) containing a plurality of DL representing the correspondence of the defect addresses inside the user area and the replacement addresses of the spare area used as the replacement destinations are recorded to a defect management information area (DMA) inside lead-in. The spare area secured on the outer peripheral side of the user area is continuously used from the lead-out side to the lead-in side.

FIG. 7 shows in detail the defect list (DL) structure used in the defect management. Each DL has a defect address inside the user area, a replacement address inside the spare area allocated by the linear replacement processing and status information representing the relation of these two kinds of information. In the drawing, portions smeared out in black represent recorded areas. The next applicant address contained in DDS presents the address M inside the spare area to be next used in the linear replacement processing. When the address N of the user area is judged as defective from this state, the user data that should have been recorded by the host to the address N is recorded in replacement to the address M inside the spare area. To represent this information, DL is constituted by “address N”, “address M” and “replacement” that represents their address relation.

FIG. 8 shows a disk for conceptually explaining a recording processing ordinarily used for the write-once optical disk and its RMD (recording management data). The drawing shows also that the data area of the optical disk is logically divided into R zones. For the sake of convenience, it will be assumed that the optical disk is logically divided into lead-in, data area (the same as user area in FIG. 8) and lead-out and that the data area is logically divided further into a plurality of R zones depending on the recording position. RMD containing two kinds of addresses, that is, the leading address of the R zones logically divided and LRA to which the user data is recorded, is recorded to RMA inside lead-in. Data recording is made continuously from the lead-in to lead-out direction in RMA and in each R zone and the addition of new R zones is made only by dividing the R zone positioned at the disk outer periphery (R zone 3 in the drawing).

FIG. 9 shows a disk for conceptually explaining logical over-write by the linear replacement processing executed on the write-once optical disk and DL of the linear replacement processing by logical over-write. In the drawing, the optical disk is divided into lead-in, lead-out and data area in accordance with the object of use and the data area is divided into two R zones, that is, R zone 1 having LRA1 as LRA and R zone 2 having LRA2. The portions smeared out in black inside the R zones represent recorded areas and white portions represent non-recorded areas. Portions with longitudinal lines represent those areas which are required for recording by the recording command from the host inside the recorded area and areas with horizontal lines represent the replacement areas inside the user area to which the drive actually records the data in response to the recording command inside the recorded area.

In the drawing, the upper disk figure shows the disk condition before the linear replacement processing for logical over-write. Under this condition, LRA1 of the R zone 1 is a physical address N−1. When the drive receives the recording command for the address smaller than LRA1, that is, for the recorded area inside the R zone 1, the drive corresponding to logical over-write executes data recording to N+(M−L) from the physical address N as the next recording position determined from LRA1 as shown in the lower disk figure. In order for the drive to represent that the data to be recorded from the physical address L on the disk corresponding to the logical address contained in the recording command to M is recorded from the physical address N to N+(M−L), two DL representing the start and the end of the replacement, that is, DL constituted by the status=replacement (start), the defect address=logical over-write start address and its replacement address, and DL constituted by the status=replacement (end), the defect address=logical over-write end address and its replacement address, are combined to form a pair and the pair is added to DLT. In this way, logical over-write can be accomplished by utilizing as such the setup of the prior art technology. However, the number of defect addresses and the number of replacement addresses sandwiched between the status=replacement (start) and the status=replacement (end) are coincident with each other, and each can be regarded as being the same as DL having the status=replacement shown in FIG. 7. Namely, the relation between the addrssL+1 and the address N+1 can be regarded as DL in which the address L+1 is the defect and the address N+1 is the replacement address and the status replacement.

In other words, logical over-write can be easily materialized in the write-once read-many optical, too, by expanding the defect management. In this case, however, the spare area becomes necessary because it is used as the replacement destination in the defect management.

Next, a recovery realization method from an accident in the data recording system to which the logical over-write processing is applied and a logical over-write cancellation method will be explained.

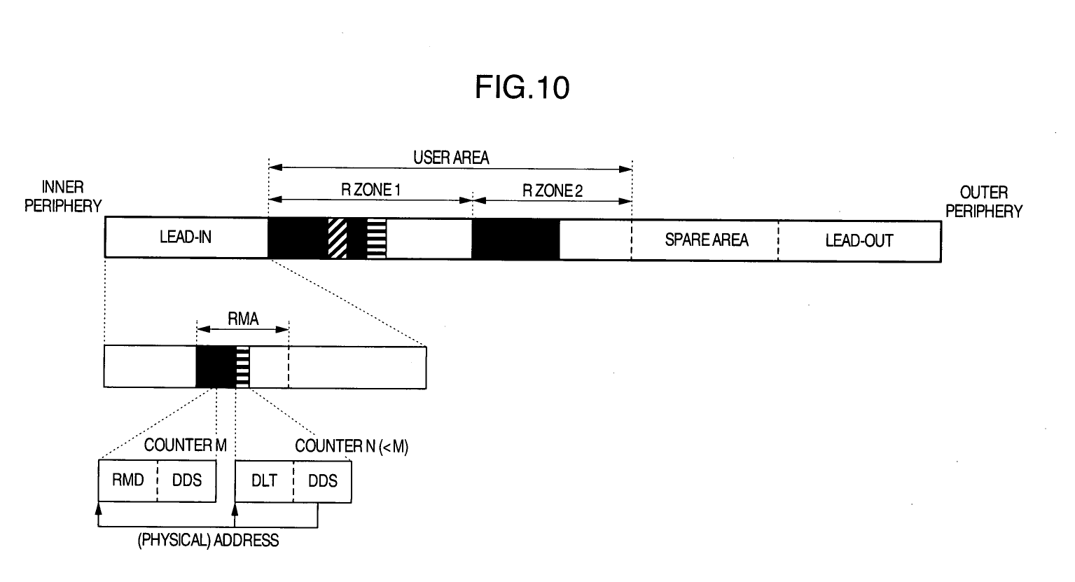

FIG. 10 shows an updating method of RMD and DLT inside RMA when the recording area management explained with reference to FIG. 9 and the defect management containing logical over-write explained with reference to FIGS. 6 to 8 are simultaneously carried out. To have the explanation more easily understood, it will be assumed hereby that each of DDS (Disk Definition Structure), DLT (Defect List Table) and RMD (Recording Management Date) is constituted by one ECC block. Since DDS contains address information representing the latest, that is, valid, recording positions of DLT and RMD, DDS is updated, too, when DLT or RMD is updated. In order to allow the drive to easily detect effective DDS at the time of loading of the optical disk, DDS is arranged at the end (outermost position) of the recording area inside RMA when updating is made. Consequently, when DDS recorded to the last part of RMA is retrieved and reproduced and RMD and DLT are read out by using the address information representing the valid recording positions of RMD and DLT contained in DDS, the drive can recover the information of the latest recording area management and defect management from the optical disk.

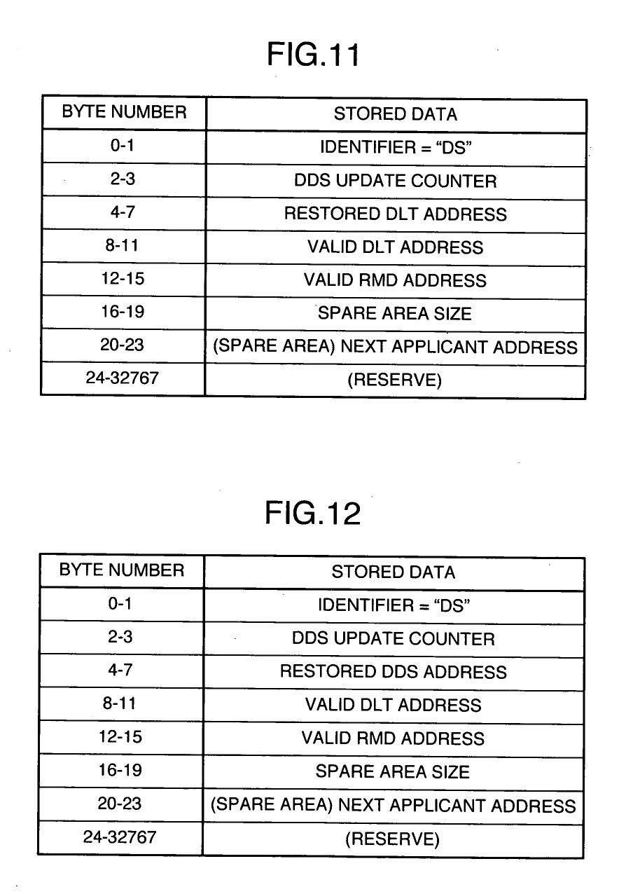

FIG. 11 mainly shows an example of the data structure of DDS arranged in RMA to materialize logical over-write cancellation for recovery. An identifier “DS” for identifying DDS is arranged at byte 0-1. A DDS update counter that is 0 at the first DDS created at the time of disk format and thereafter increments one by one whenever DDS is updated is arranged at byte 2-3. A recovery DLT address is arranged at byte 4-7. A valid DLT address representing the address to which valid DLT is recorded is arranged at byte 8-11. A valid RMD address representing the address to which valid RMD is recorded is arranged at byte 12-15. A space area size designating the spare area size secured inside the user area in terms of the ECC block number is arranged at byte 16-19. A next applicant address designating the address of the replacement destination to be next used inside the space area for the defect is arranged at byte 20-23. The recovery DLT address arranged at byte 4-7 represents the address inside RMA to which DLT is recorded under the state where the host judges that the file management information recorded onto the optical disk and the file have no contradiction.

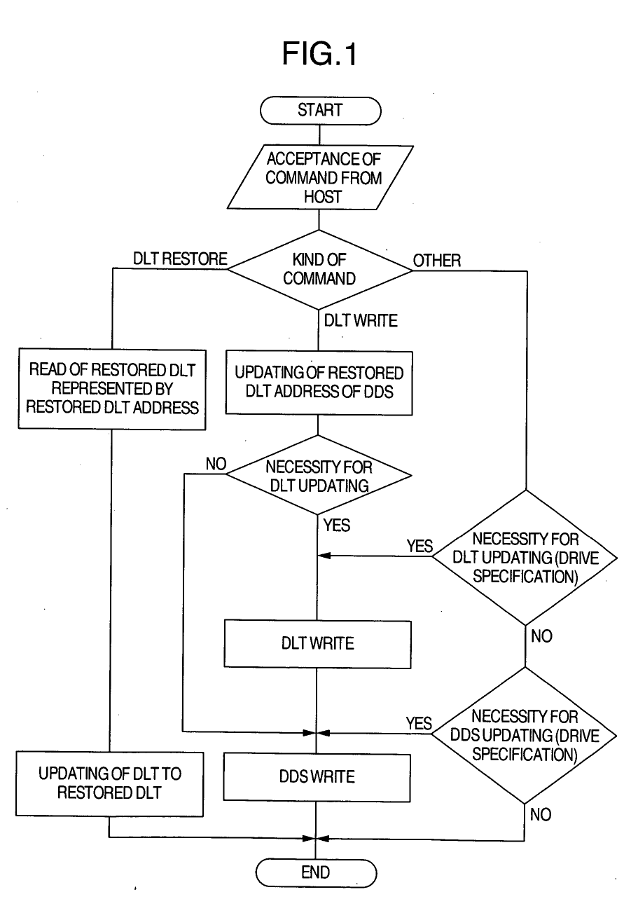

FIG. 1 is a flowchart showing an updating method of DDS for managing the recovery DLT address shown in FIG. 11 and the procedure of a recovery processing for recovering the state of the file arranged on the disk to the state free from contradiction when an accident occurs. The drive receives the command from the host. When the command is a DLT recording command instructing recording of the latest DLT managed by the drive on RAM onto the optical disk, the same value as the valid DLT address of the byte 8-11 is set to the recovery DLT address of the byte 4-7 of DDS, and DLT and DDS on RAM are then recorded to RMA of the optical disk. However, when valid DLT on RAM is the same as last DLT recorded to RMA, it is not necessary to again record DLT to the optical disk. In ordinary drives, updating of recording of DLT and RMD to RMA is executed at a particular timing in accordance with the data quantity added, the defect and logical over-write, whenever necessary. In this case, updating of recording of the recovery DLT address inside DDS is executed while the value of the recovery DLT address of preceding DDS is held. Because the host controls updating of the recovery DLT address of DDS in this way, the drive returns valid DLT on RAM to DLT designated by the recovery DLT address in accordance with the DLT recovery command instructing recovery to DLT to which the host gives the recording command and the optical disk can be again recovered under the state in which matching of the contents of the logical volumes is maintained. In this description, the explanation is given to the effect that the recovery DLT address is updated before DLT is recorded in response to the DLT recording command from the host but the same effect can be acquired by the steps of recording DLT to the optical disk, then updating the recovery DLT address inside DDS and recording DDS. When the valid DLT address of DDS is updated by recording DLT in an actual drive and checking whether or not DLT is correctly recorded, it would be more practical to first record DLT and then to conduct updating of the recovery address in combination with updating of the valid DLT address.

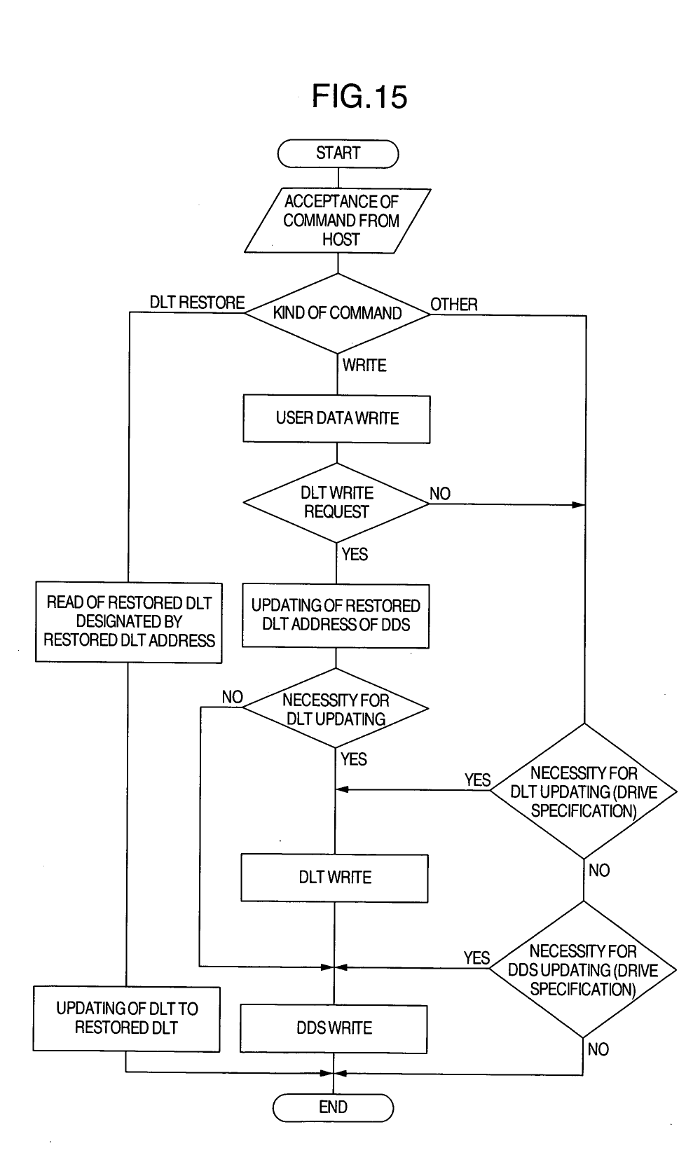

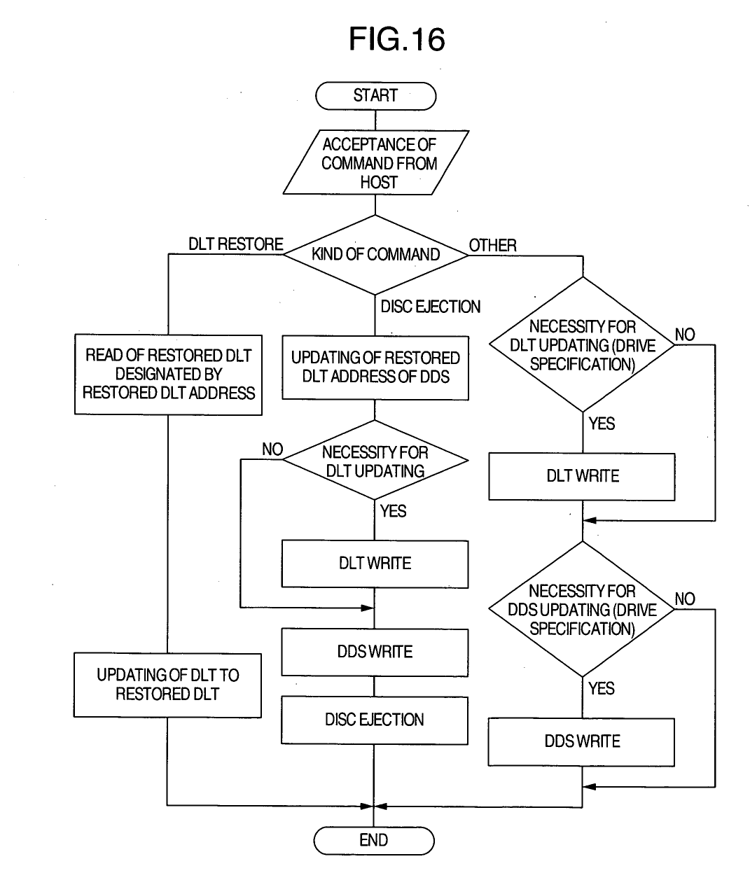

FIGS. 15 and 16 are flowcharts showing an updating method of DDS for managing the recovery DLT address and the procedures of a recovery processing for recovering again the logical volume content of the file system arranged on the disk to the state where matching is established when an accident occurs, in the same way as in FIG. 1. The difference from FIG. 1 resides in the recovery DLT address updating timing of DDS recorded, that is, an instruction method for the host to let the drive record DLT. FIG. 15 shows an example where a flag instructing a DLT recording request is added to the recording command and when this flag represents the DLT recording request, the value of the recovery DLT address is updated after the recording processing of the user data is complete and then DLT and DDS are recorded. However, the DLT recording control method by the host is not limited to the recording command and control can be similarly made when a flag instructing the DLT recording request is added to other command. FIG. 16 shows an example where the recovery DLT address is updated by a disk ejection command and DDS and DLT are recorded to the optical disk. However, this DLT recording control method is not limited to the disk ejection command but some other commands are suitable for controlling the recover DLT address in the same way.

FIG. 12 shows another example of the data structure of DDS arranged on RMA for accomplishing the logical over-write cancellation for recovery and different from the example shown in FIG. 11. An identifier “DS” for identifying DDS is arranged at byte 0-1. A DDS update counter that is 0 at the first DDS generated at the time of disk format and increments one by one whenever DDS is updated is arranged at byte 2-3. A recovery DDS address is arranged at byte 4-7. A valid DLT address representing the address at which valid DLT is recorded is arranged at byte 8-11. A valid RMD address representing the address at which valid RMD is recorded is arranged at byte 12-15. A space area size designating by an ECC block number the space area size secured inside the user area is arranged at byte 16-19. A next applicant address designating the address of the replacement destination to be next used inside the space area for the defect is arranged at byte 20-23. The recovery DDS address arranged at byte 4-7 represents the address of RMA to which DDS containing the valid DLT address as DLT under the state where the host judges that file management information recorded to the optical disk and files have no contradiction is recorded.

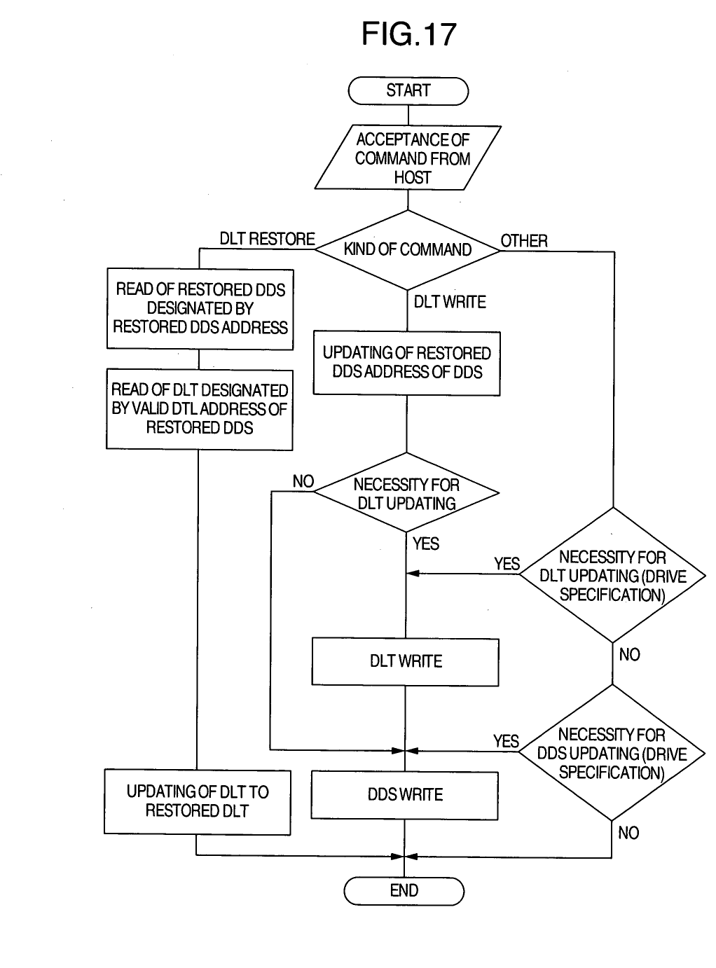

FIG. 17 is a flowchart showing an updating method of DDS for managing the recovery DDS address shown in FIG. 12 and the procedure of the recovery processing for recovering the state of the files arranged on the disk to the state free from contradiction when the accident occurs. The drive accepts the command from the host. When the command is the DLT recording command that instructs recording of the latest DLT the drive manages on RAM to the optical disk, the address of RMA to which this DDS is recorded is set to the recovery DDS address of byte 4-7, and DLT and DDS are then recorded. In ordinary drives, updating of recording of DLT and RMD to RMA is executed at a peculiar timing in accordance with the data quantity added, the defect and logical over-write, whenever necessary. In this case, updating of recording of the recovery DLT address inside DDS is executed while the value of the recovery DDS address of preceding DDS is held. When the accident occurs as the host controls updating of the recovery DDS address inside DDS in this way, the drive returns DL to be used for data reproduction to DLT recorded to the valid DLT address of past DDS designated by the recovery DDS address to DLT designated by the recovery DLT address in accordance with the command instructing recovery of DL. In this way, file management information arranged on the disk and the file condition can be again recovered to the state free from contradiction. In this description, the explanation is given to the effect that the recovery DDS address is updated before DLT is recorded in response to the DL updating command from the host but the same effect can be acquired by the steps of updating the recovery DDS address immediately before DDS is recorded and then recording DDS. DLT is recorded in practice, whether or not DLT is correctly recorded is checked and DLT is again recorded when recording is not made correctly. Therefore, the recording position of DDS varies. It is thus possible to believe that updating of the recovery DDS address immediately before recording of DDS is more practical.

In the case of FIG. 17, too, the system explained with reference to FIGS. 15 and 16 can be used as the decoding DDS address updating timing of DDS. In this case, the drive executes the recovery processing of DLT on RAM used for data reproduction to DLT recorded to the valid DLT address of DDS designated by the recovering DDS address in response to the DLT recovery command shown in FIGS. 15 and 16.

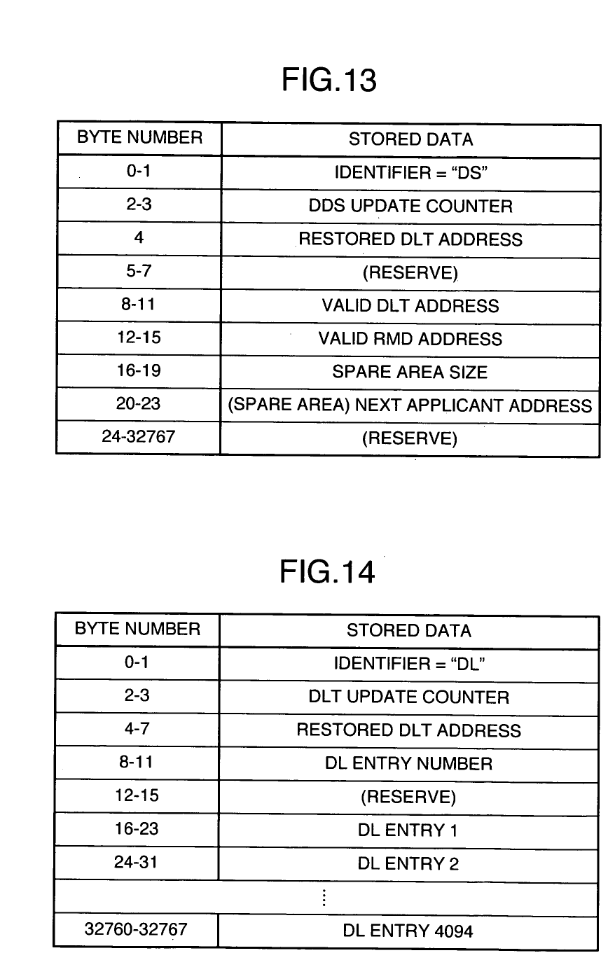

FIG. 13 mainly shows another example of the data structure of DDS arranged on RMA for accomplishing the logical over-write cancellation for recovery and different from the example shown in FIGS. 11 and 12. An identifier “DS” for identifying DDS is arranged at byte 0-1. A DDS update counter that is 0 at the first DDS generated at the time of disk format and increments one by one whenever DDS is updated is arranged at byte 2-3. A recovery DDS flag is arranged at byte 4. A valid DLT address representing the address at which valid DLT is recorded is arranged at byte 8-11. A valid RMD address representing the address at which valid RMD is recorded is arranged at byte 12-15. A space area size designating by an ECC block number the space area size secured inside the user area is arranged at byte 16-19. A next applicant address designating the address of the replacement destination to be next used inside the space area for the defect is arranged at byte 20-23. The recovery DDS flag arranged at byte 4 represents whether or not file management information recorded by the host to the optical disk and files are under the state where they have no contradiction.

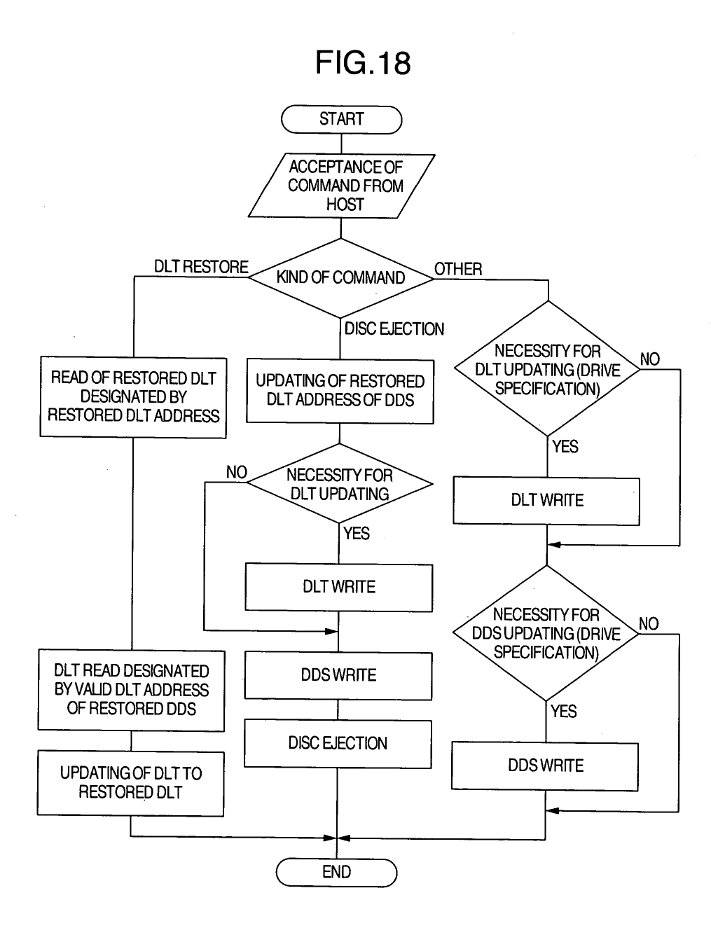

FIG. 18 is a flowchart showing an updating method of DDS for managing the recovery DDS flag shown in FIG. 13 and the procedure of the recovery processing for recovering the state of the files arranged on the disk to the state free from contradiction when an accident occurs. The drive accepts the command from the host. When the command is the disk ejection command instructing ejection of the optical disk inside the drive, the drive adds the recovery DDS flag of byte 4, then records DLT and DDS and executes disk ejection. In ordinary drives, updating of recording of DLT and RMD to RMA is executed at a peculiar timing in accordance with the data quantity added, the defect and logical over-write, whenever necessary. In this case, the recovery DDS flag inside DDS is not added. When an accident occurs as the drive adds the recovery DDS flag inside DDS at the time of normal finish in this way, the drive returns DL to be used for data reproduction to DLT recorded to the valid DLT address contained in the last DDS to which the recovery DDS flag inside RMA is set, and can recover the file management information arranged on the disk and the files to the state free from contradiction.

In the case of FIG. 18, too, no problem occurs when the DLT recording command from the host explained with reference to FIGS. 1 and 15 is introduced and DDS to which the recovery DDS flag of DLT and DDS is added is recorded. The drive operation for the DLT recovery command shown in FIGS. 1 and 15 becomes an updating processing of DLT inside RAM to be used for data reproduction to DLT recorded to the valid DLT address contained in the past DDS to which the recovery DDS flag is added.

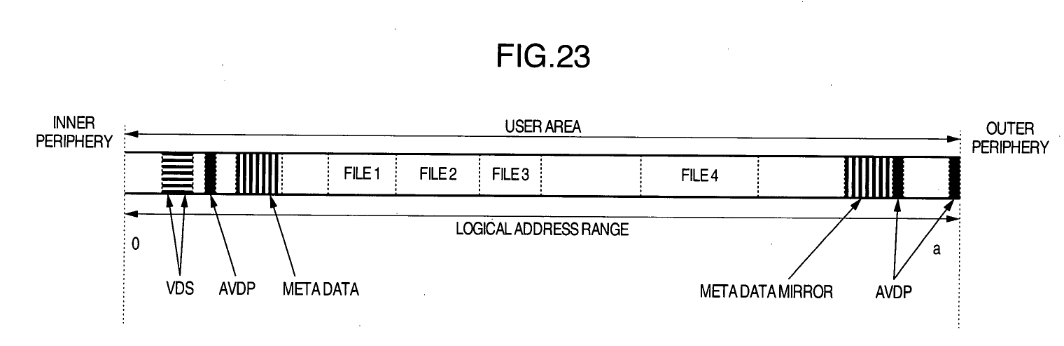

FIG. 23 shows file management information of Revision 2.50 of UDF as a typical file system of optical disks and the arrangement of files on the disk. AVDP is recorded to at least two positions of a sector of LBN=256, the last sector (LBN=Z) and LBN=Z-256. This AVDS contains address information to which VDS (main VDS and sub-VDS) containing two volumes of information are recorded. To this VDS are recorded information representing whether or not the content of the logical volumes has matching, the total number of logical blocks in the logical volumes and the recording positions of Meta Data containing FSD and ICB of each file and Meta Data Mirror as a copy of the Meta Date. Therefore, the data to which logical over-write is applied is believed mainly any of Meta Data, VDS and AVDS. This embodiment assumes a system for updating VDS by logical over-write. In this case, the host itself can achieve recovery by using the information representing whether or not the content of the logical volumes inside VDS is under the state having matching. When logical over-write is executed, however, the data recorded in the past is the data that cannot be read out from the host, that is, under the non-recoverable state. Therefore, a system is necessary that lets the drive go up one by one to DLT until the logical volume reaches the state having matching.

FIG. 14 mainly shows an example of a data structure of DTL arranged on RMA for accomplishing logical over-write for recovery. An identifier “DL” for identifying DLT is arranged at byte 0-1. A DLT update counter that is 0 at the first DL generated at the time of disk format and increments one by one whenever DLT is updated is arranged at byte 2-3. A recovery DLT address is arranged at byte 4-7. A number of DL having replacement status constituting DLT is arranged at byte 8-11. DL constituted by status, defect address and replacement address are arranged at 8 bytes after byte 16. The recovery DLT address arranged at byte 4-7 of DLT at DLT update counter=N represents the address inside RMA to which DLT for setting the DLT update counter to N−1 is recorded.

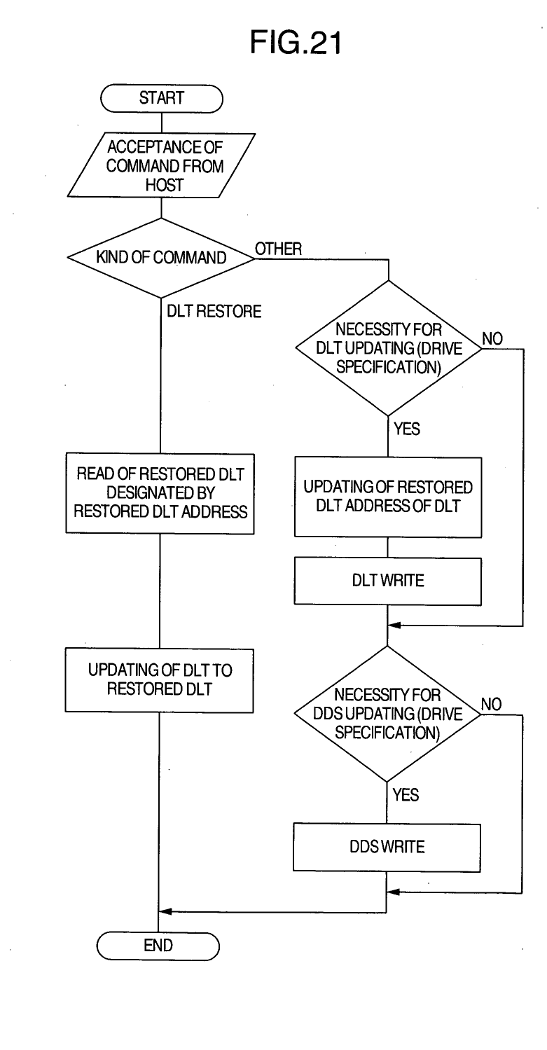

FIG. 21 is another flowchart showing an updating method of DLT for managing the recovery DLT address shown in FIG. 14 and the procedure of the recovery processing for recovering the state of the disk to the state to the original state when an accident occurs. When record-updating DLT inside RMA, the drive sets the valid DLT address of byte 8-11 of DDS to the recovery DLT address of byte 4-7, then records DLT, updates the valid DLT address of byte 8-11 of DDS and records DDS. When the address of just one preceding DLT is recorded to the recovery DLT address inside DLT in this way, the drive returns DLT used for data reproduction to the previous DLT designated by the recovery DLT address in accordance with the command instructing DLT recovery and can again return the file management information arranged on the disk and the file state to the past state. Consequently, it becomes possible to reproduce data while DLT from the host is updated and to go up to the recovery address in response to the request for retrospection until the file management information arranged on the optical disk and the files again reach the state free from contradiction.

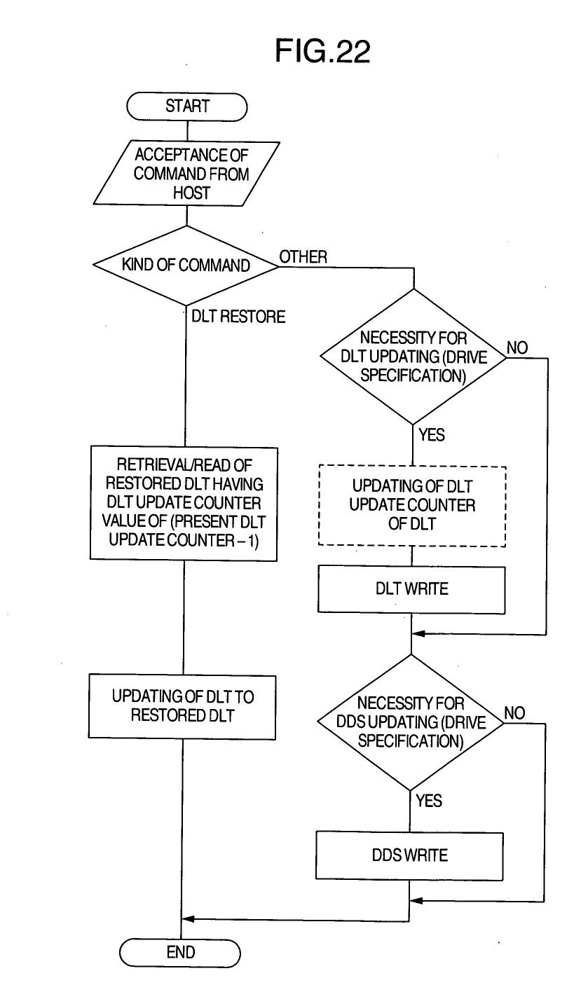

FIG. 22 shows an example of a flowchart for a recovery processing at the time of accident when specific data is not used for DDS and DLT for DLT recovery, and the procedure for canceling the over-write processing. The drive again recovers the file management information arranged on the disk and the state of the files to the past state by returning DLT used for data reproduction to DLT having the DLT update counter of “present DLT update counter 1” in accordance with the DLT recovery command instructing DLT recovery. In this case, the drive needs the retrieval time for searching corresponding DLT from inside RMA but when the time renders no problem, this is believed to be one of the effective methods for accomplishing recovery. In this case, however, a system is separately necessary in which DLT must be able to be retrograded by one or the DLT update counter of DLT must be decreased one by one with retrospection. Therefore, this problem is avoided by adding information for selecting past DLT to the DLT recovery command.

FIG. 22 shows an example of a flowchart for a recovery processing at the time of accident when specific data is not used for DDS and DLT for the DLT recovery function in the same way as in FIG. 22. The drive recovers DLT used for data reproduction to DLT having the DLT update counter contained in the DLT recovery command in accordance with the DLT recovery command instructing DLT recovery containing the recovery DLT update counter information and recovers again the file management information arranged on the disk and the files to the past state. Another method as similar means designates the number of retrospection of the DLT update counter besides the method that instructs the DLT update counter. In other words, the number of retrospection of the DLT update counter=1, DLT used for data reproduction is returned to DLT having the DLT update counter of “DLT update counter 1 of present DLT” to recover again the file management information arranged on the disk and the state of the files to the past state. When the number of retrospection of DLT update counter=2, DLT used for data reproduction is returned to DLT having the DLT update counter of “DLT update counter 2 of present DLT” to recover again the file management information arranged on the disk and the state of the files to the past state.

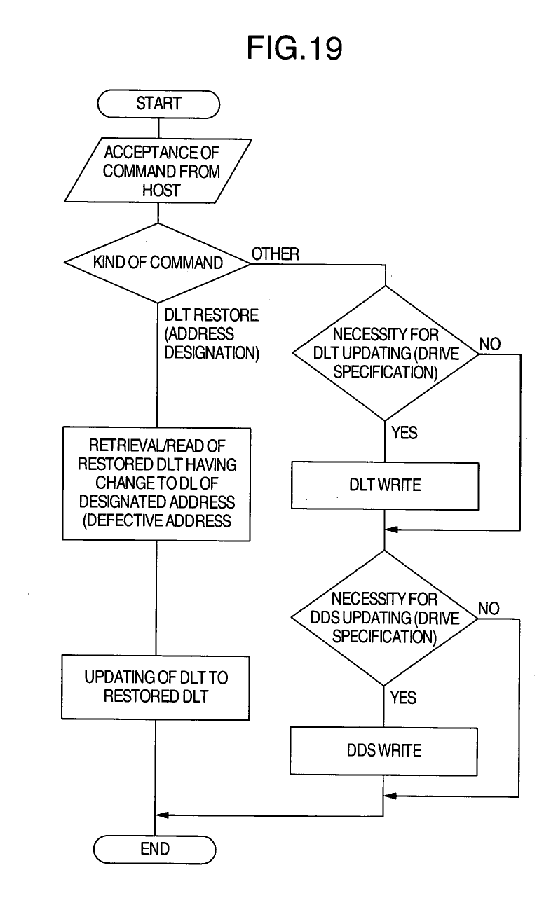

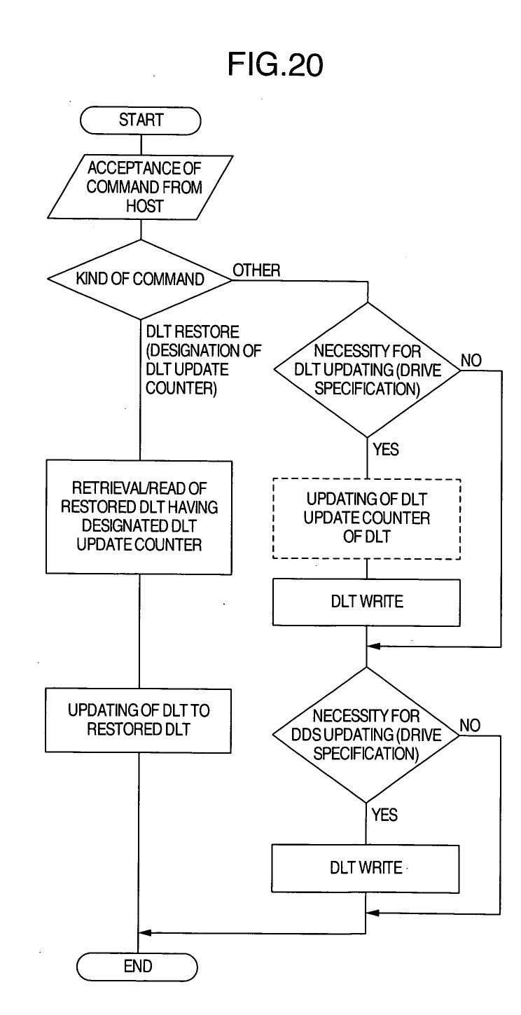

FIG. 19, too, shows another example of a flowchart for a recovery processing at the time of accident without using any specific data for DDS and DLT for the DLT recovery function in the same way as in FIG. 20. The drive recovers DLT used for data reproduction to DLT having the DLT before the change of the replacement destination of the address contained in the DLT recovery command to again recover the file management information arranged on the disk and the state of the files to the past state. For example, it will be assumed hereby that the replacement destination of AVDP of the address 256 changes from 257 to 258 and then to 259 and the latest DL of the update counter=N is (status, defect address, replacement address)=(replacement, 256, 259), (status, defect address, replacement address)=(replacement, 256, 259) at the DLT update counter=M, (status, defect address, replacement address)=(replacement, 256, 258) at the DLT update counter=M−1, DLT is recovered to DLT of the DLT update counter=M−1. When the DLT recovery command containing this address information is so expanded as to contain the update number-of-times information, recovery is executed to DLT of the DLT update counter=M−1 for the DLT recovery command having the address 256 at update number of times=1, and to the last DLT satisfying (status, defect address, replacement address)=(replacement, 256, 257) for the DLT recovery command having the address 256 at update number of times=2. In this way, freedom can be improved.

In the last place, a recovery materialization method from the accident in the optical disk recording/reproducing apparatus corresponding to the logical over-write processing of the write-once optical disk will be demonstrated.

The construction of the optical disk recording apparatus is the same as the construction of the optical disk recording/reproducing apparatus shown in FIG. 4. In FIG. 4, reference numeral 401 denotes an optical disk. Reference numeral 402 denotes an optical head including a laser diode and a light detector that are mounted to the optical head. Reference numeral 403 denotes a recording/reproducing signal processing circuit for executing an encoding processing for reproduction and a decoding processing for reproduction. Reference numeral 404 denotes a control microcomputer for executing operation management of each block. Reference numeral 405 denotes a servo circuit. Reference numeral 406 denotes an interface circuit with a host containing RAM. Reference numeral 407 denotes an input/output terminal.

At the start, the optical disk recording/reproducing apparatus reads out the latest DDS information recorded to the last part of the recording area of RMA on the optical disk 401 and transfers this information to a temporary storage circuit such as RAM built in the interface 406 that is accessible from the control microcomputer 404. Next, the optical disk recording/reproducing apparatus reads out DL and RMD from a valid DLT address and a valid RMA address contained in DDS and transfers them to the temporary storage circuit built in the interface 406 in the same way as DDS.

During recording, a command instructing a drive operation and user data whenever necessary, are inputted from the host through the input/output terminal 407. When the recording command is inputted in the ordinary drive operation in the same way as in the prior art, the control microcomputer calculates and determines the physical address corresponding to the logical address contained in the recording command and judges from RMD whether the physical address area is recorded or is not recorded. When the physical address is not yet recorded, an instruction of the data transfer is sent to the host and the user data transferred from the host is stored in RAM inside the interface circuit 406 in accordance with the command of the control microcomputer 405. At the same time, the control microcomputer 405 executes the seek processing to the physical address determined by using the servo circuit 405. After the recording/reproducing signal processing circuit 403 executes the encoding processing such as the scramble processing, the error correction encoding processing and the modulation processing, the write processing is executed to the physical address area as the object on the optical disk 401. When the physical address corresponding to the logical address contained in the recording command has already been recorded, allocation of a new physical address is made by adding new DL to DLT and the instruction of the data transfer is given to the host. The user data transferred from the host is stored in RAM inside the interface circuit 406 in response to the instruction of the control microcomputer 405. At the same time, the control microcomputer 405 executes the seek processing to the physical address allocated afresh as the replacement address by using the servo circuit 405. After the recording/reproducing signal processing circuit 403 executes the encoding processing such as the scramble processing, the error correction encoding processing and the modulation processing, the write processing is executed to the physical address area afresh allocated as the object on the optical disk 401 through the optical head 402.

Similarly, the control microcomputer 405 appropriately judges and executes control for each kind of commands inputted from the host through the input/output terminal 407.

To write a part of information such as the recovery DLT address for DDS and DL for the purpose of DLT recovery at the time of updating of DL that has been explained with reference to FIGS. 1, 15, 16, 17, 18 and 21, the control microcomputer updates the necessary position of byte 4-7 of DDS or DL stored in RAM inside the interface circuit 406 at the time of updating and executes the seek processing to the next recording address of RMA by using the servo circuit 405 in the same way as the recording processing of the user data. After the recording/reproducing signal processing circuit 403 executes the encoding processing such as the scramble processing, the error correction encoding processing and the modulation processing, the write processing to the physical address area as the object on the optical disk 401 is made. The control microcomputer 405 finds out the physical address at which the intended DLT is recorded from the information such as the recovery DLT address contained in DDS or DLT stored in RAM inside the interface circuit 406 in response to the DLT recovery command and executes the seek processing to this physical address by using the servo circuit 405. After the recording/reproducing signal processing circuit 403 executes the demodulation processing, the error correction processing and the de-scramble processing, the reproduction signal read out from the physical address area as the object through the optical head 402 is transferred to the temporary storage circuit built in the interface circuit 406. DLT thus read out is replaced similarly by the latest DLT stored in the temporary storage circuit and a preparation operation for subsequent command from the host is made.

The control microcomputer 405 executes the seek processing to the address at which DDS stored in RAM inside the interface circuit 406 is recorded or near the valid DLT address contained in DDS by using the servo circuit 405. The recording/reproducing signal processing circuit 403 executes the demodulation processing, the error correction processing and the de-scramble processing for the reproduction signal read out through the optical head 402 and the signal is then transferred to the temporary storage circuit built in the interface 406. The object DLT is sought theoretically and retroactively from inside RMA with reference to the identifier, DDS, the DLT update counter or DL containing the predetermined address of DLT and is replaced by the latest DLT stored in the temporary storage circuit. The preparation operation for subsequent commands from the host is then made.

The invention can provide the use environment analogous to that of the re-loadable optical disk such as data over-write and defect management to the write-once optical disk while the functions of the write-once optical disk of the prior art such as prevention of physical data forfeit and recovery of data are maintained. Therefore, the optical disk of the invention is expected to enlarge the ordinary usage of the future write-once optical disks.

It should be further understood by those skilled in the art that although the foregoing description has been made on embodiments of the invention, the invention is not limited thereto and various changes and modifications may be made without departing from the spirit of the invention and the scope of the appended claims.

1. A recording method of a write-once optical disk which has a lead-in area, a user area and a lead-out area and to which a logical over-write processing is performed using disk structure definition information and a defect list table recorded to said lead-in area, comprising the steps of:
recording as said disk structure definition information, information regarding said disk structure definition information or said defect list table that is to be referred to for a logical over-write cancellation processing, in said lead-in area; and
performing said logical over-write cancellation processing before recording to said user area, on the basis of said recorded information.

2. A recording method of a write-once optical disk according to claim 1, wherein said information regarding said disk structure definition information or said defect list table that is to be referred to for said logical over-write cancellation processing is position information to which said defect list table used after said logical over-write cancellation processing is recorded.

3. A recording method of a write-once optical disk according to claim 1, wherein said disk structure definition information includes position information to which said defect list table is recorded, and said information regarding said disk structure definition information or said defect list table that is to be referred to for said logical over-write cancellation processing is position information to which said disk structure definition information including said defect list table used after said logical over-write cancellation processing as position information is recorded.

4. A recording method of a write-once optical disk according to claim 1, wherein said disk structure definition information includes position information to which said defect list table is recorded, and said information regarding said disk structure definition information or said defect list table that is to be referred to for said logical over-write cancellation processing is information including said defect list table used after said logical over-write cancellation processing as position information.

5. A recording method of a write-once optical disk which has a lead-in area, a user area and a lead-out area and to which a logical over-write processing is performed using disk structure definition information and a defect list table recorded to said lead-in area, said method comprising the steps of:
recording information regarding said defect list table that is to be referred to for a logical over-write cancellation processing, in said lead-in area; and;
performing said logical over-write cancellation processing before recording to said user area on the basis of said information regarding said defect list table recorded.

6. A recording method of a write-once optical disk according to claim 5, wherein said information regarding said defect list table that is to be referred to for said logical over-write cancellation processing is position information to which said defect list table used after said logical over-write cancellation processing is recorded.

7. An optical recording apparatus for performing a logical over-write processing for a write-once optical disk by using disk structure definition information and a defect list table, comprising:
processing means for adding information regarding said disk structure definition information or said defect list table that is to be referred to for a logical over-write cancellation processing, to said disk structure definition information; and
recording means for recording a recording object to said optical disk on the basis of said information added by said processing means.

8. An optical disk recording apparatus according to claim 7, wherein said information regarding said disk structure definition information or said defect list table that is to be referred to for said logical over-write cancellation processing is position information to which said defect list table used after said logical over-write cancellation processing is recorded.

9. An optical disk recording apparatus according to claim 7, wherein said disk structure definition information includes position information to which said defect list table is recorded, and said information regarding said disk structure definition information or said defect list table that is to be referred to for said logical over-write cancellation processing is position information to which said disk structure definition information including said defect list table used after said logical over-write cancellation processing as position information is recorded.

10. An optical disk recording apparatus according to claim 7, wherein said disk structure definition information includes position information to which said defect list table is recorded, and said information regarding said disk structure definition information or said defect list table that is to be referred to for said logical over-write cancellation processing includes said defect list table used after said logical over-write cancellation processing as position information.

11. An optical disk recording apparatus for performing a logical over-write processing to a write-once optical disk by using disk structure definition information and a defect list table, comprising:
processing means for adding information regarding said defect list table that is to be referred to for a logical over-write cancellation processing, to said defect list table; and
recording means for recording a recording object to said optical disk on the basis of said information added by said processing means.

12. An optical disk recording apparatus according to claim 11, wherein said information regarding said defect list table that is to be referred to for said logical over-write cancellation processing is position information to which said defect list table to be used after said logical over-write cancellation processing is recorded.

13. An optical disk reproducing apparatus for reproducing a write-once optical disk to which disk structure definition information and a defect list table used for logical over-write are recorded, comprising:
means for accepting a defect list table recovery command from a host; and
updating means for updating said defect list table by referring to information regarding said disk structure definition information or said defect list table included in said disk structure definition information.

14. An optical disk reproducing apparatus according to claim 13, wherein said information regarding said disk structure information or said defect list table that is referred to in response to said defect list table recovery command from the host is position information to which said defect list table used after said over-write cancellation processing is recorded.

15. An optical disk reproducing apparatus according to claim 13, wherein said disk structure definition information includes position information to which said defect list table is recorded, and said information regarding said disk structure definition information or said defect list table that is referred to in response to said defect list table recovery command from the host is position information to which said disk structure definition information including said defect list table used after said logical over-write cancellation processing as position information is recorded.

16. An optical disk reproducing apparatus according to claim 13, wherein said disk structure definition information includes position information to which said defect list table is recorded, and said information regarding said disk structure definition information or said defect list table that is referred to in response to said defect list table recovery command from the host is information including said defect list table used after the logical over-write cancellation processing as position information.

17. An optical disk reproducing apparatus for reproducing a write-once optical disk to which disk structure definition information and a defect list table used for logical over-write are recorded, comprising:
acceptance means for accepting a defect list table recovery command from a host; and
updating means for updating said defect list table by referring to said disk structure definition information included in said defect list table or information regarding said defect list table.

18. An optical disk reproducing apparatus according to claim 17, wherein said information regarding said defect list table referred to in response to said defect list table recovery command from the host is position information to which said defect list table used after a logical over-write cancellation processing is recorded.

19. An optical disk reproducing apparatus for reproducing a write-once optical disk which has a lead-in area, a user area and a lead-out area and in which disk structure definition information and a defect list table used for logical over-write are continuously updated and recorded inside a recording area management information area of said lead-in area, comprising:
means for accepting a defect list table recovery command from a host; and
updating means for searching a defect list table designated by said defect list table recovery command from inside said recording are management information area and updating said defect list table.

20. An optical disk reproducing apparatus according to claim 19, wherein designation of said defect list table included in said defect list table recovery command is performed by using an update counter included in said defect list table.

21. An optical disk reproducing apparatus according to claim 19, wherein designation of said defect list table included in said defect list table recovery command is performed by using a defect address included in said defect list table.
